(19) United States
(12) Patent Application Publication
(10) Pub. No.: US 2007/0262098 A1
(43) Pub. Date: Nov. 15, 2007

(54) Method for Moulding and Assembling Parts and Product-Dispensing Head in Particular Obtained by Said Method

(76) Inventor: Pascal Gons, Champagne Sur Oise (FR)

Correspondence Address: YOUNG & THOMPSON, 745 SOUTH 23RD STREET, 2ND FLOOR, ARLINGTON, VA, 22202, US

(21) Appl. No.: 11/660,446

(22) PCT Filed: Aug. 18, 2005
(86) PCT No.: PCT/FR05/02102

§ 371 Date: Apr. 16, 2007

(30) Foreign Application Priority Data
Aug. 20, 2004 (FR) 0409032

(51) Int. Cl. B67D 3/00; B65D 83/40; B29C 41/42

(52) U.S. Cl. 222/481; 264/334; 222/525; 222/556

(57) ABSTRACT

The invention concerns a method for moulding and assembling at least one first part (101) and at least one second part (2) comprising the following steps: moulding and assembling, in two separate cavities of a common moulding device, said first part and second part, said first part including at least one spike (3, 4) said spike comprising a recess overmoulded on the end of a retaining rod, said second part comprising at least one catching orifice (21, 23) traversed by said retaining rod, whereon each spike (3, 4) is designed to be subsequently attached. The invention also concerns a product-dispensing head (TD1′) in particular obtained by said method.

The present invention relates to a method for molding and assembling parts in the same molding device and a product-dispensing head in particular obtained by this method.

Among injection molding systems of the multimaterial or multicolor type, molding devices that are known in particular are those termed “transfer molding devices” wherein the molded part is transferred, by a robot for example, toward another molding cavity after cooling, in order to undergo to overmolding.

This type of device makes it possible to obtain molded products including several materials or even several colors. However, this type of device, which can employ robotized systems is costly. Moreover, this device requires two molding cavities per molded part and therefore has the disadvantage of being bulky. In addition, this device involves moving the molded part before overmolding it, which risks damaging the molded part at least superficially. In order to prevent this risk of deterioration, the cooling period for the molded part after molding needs to be extended, which involves a loss of time and consequently a reduction in the productivity of this type of method.

According to another injection molding device of the multimaterial type termed a “rotary plate type”, the molded part is moved in translation by the rotary plate toward another molding cavity in order to be overmolded. This device has the advantage of not involving movement of the molded part but only that of the rotary plate which substantially limits the risks of deformation before overmolding. However, this type of device is very costly and bulky and it is difficult to adjust the rotation of the plate satisfactorily.

Finally, according to the molding device termed a “gate system molding device”, the molding cavity is partially open so as to leave a space that will be filled with the overmolding material. This device is not bulky since it only requires one molding cavity per molded part, but molding by this type of device has low productivity.

The object of the invention is therefore to provide a method for molding and assembling parts which avoids the aforementioned disadvantages and which permits molding that is easily put into practice and gives high productivity. The subject of the invention is also a dispensing head that can incorporate various materials and can in particular be obtained by the method of the present invention.

To this end, the object of the invention is a method for molding and assembling at least one first part with at least one second part comprising steps consisting in:
molding, in two separate molding cavities of the same molding device, said first and second parts, said first part including at least one fastener, said fastener having a recess overmolded on the end of a retaining rod, said second part having at least one latching orifice traversed by said retaining rod, on which each fastener is designed to be subsequently latched;
partial demolding so as to free at least the space included between the first molded part and the second molded part while holding said first part by the end of the retaining rod;
assembling the first part and the second part by a relative movement of the first part and/or of the second part until each fastener is engaged on the corresponding said latching orifice,
   the frictional forces between at least one said recess and said end of a retaining rod being greater than the force for inserting said fastener through the latching orifice; and
Ejecting the assembled first part and second part.

Advantageously, said molding cavities are arranged in relation to each other so that the relative movement for assembling said first part and said second part is a translational movement.

Preferably, the first part is stationary and the second part slides, advantageously pushed by a stripping device, toward the first part until the fastener is completely engaged in the latching orifice. The first and second parts are then mechanically secured to each other by snap-fastening. They then form an assembly, preferably consisting of two materials, which can be of different colors. The materials that can be used in the present invention are for example any plastics having properties close to those of polypropylene.

Thus, the method according to the invention proceeds in a single molding device and only involves conventional molding equipment, namely an injection mold with several cavities and a press. In addition, the method according to the invention permits injection molding of the multimaterial or multicolor type that is easy to put into practice and has high productivity.

The subject of the invention is also a product-dispensing head comprising an endpiece designed to be placed on a receptacle containing a product to be dispensed, said endpiece comprising a dispensing orifice, said product-dispensing head comprising a cover designed to close said dispensing orifice of said endpiece, said cover having at least one fastener, said endpiece having at least one latching orifice designed to receive said fastener and a stop positioned laterally outside said latching orifice, said fastener having a body extending projecting from the plane of said cover in a direction termed the “longitudinal direction” away from the cover, said fastener having at least one latching lug connected to said body, said at least one latching lug is inclined with respect to said longitudinal direction toward the plane of said cover in the direction of said body, said at least one latching lug is capable of folding back longitudinally against said body when passing into the latching orifices, of folding back after passing into the latching orifices and of butting up against the stop of the endpiece.

The latching lug can have different shapes: for example the shape of a continuous or discontinuous flat or conical collar positioned laterally around the fastener.

Preferably, said latching lug is flat and perpendicular to the plane termed the “demolding plane” of the cover. In this case, the latching lug does not constitute a back draft, that is to say its general shape does not prevent demolding. The latching lug is therefore easily demolded and does not exhibit deformations and embrittlement induced by force demolding.

According to a feature of the invention, said fastener has a cross section of which the larger dimension is perpendicular to said demolding plane.

Preferably, said recess has a non-circular section matching the shape of said fastener. For example, said recess has a rectangular section. In this case, the retaining rod of which the end molds the recess, is blade-shaped. The fact of using a retaining rod in the form of a blade and particular a wide blade, makes it possible to increase the frictional surface area between the end of the retaining rod and the recess. In this way, the greater forces for inserting the fastener through the latching orifice can be employed for assembling the first and second parts, which involves the possibility of using materials constituting the cover in particular, that are more rigid and/or solid.

According to another feature of the invention, the fastener has at least two latching lugs that are symmetrical with respect to the middle plane of the fastener perpendicular to said demolding plane.

According to a first embodiment, said endpiece has a dispensing orifice and said cover has at least one first anchoring part of which the lower part defines the fastener, and an articulated part, said articulated part being connected to said first anchoring part by a part forming a hinge, said cover closing said dispensing orifice in a position termed the “closed position”.

According to a particular form of the first embodiment, said cover additionally has a second anchoring part separated from said first anchoring part by said articulated part, said articulated part being connected to said second anchoring part by a detachable part. The detachable part is used as a tamper-evident device, this type of device being preferably used for products of which the integrity must be preserved before a first use, for example hygienic products. This type of tamper-evident device can moreover be incorporated in another part of the dispensing head according to the invention, for example between the articulated part and the upper wall of the endpiece outside the primary or secondary anchoring parts. In addition, this type of tamper-evident device can moreover be incorporated in any dispensing head even if the latter does not include the fastener as previously described.

Advantageously, said detachable part is in the form of a tongue projecting from the side of the wall termed the “upper wall” of said cover, said tongue being torn off before the dispensing head is first used.

The detachable part consists for example of a strip separated from the first articulated part and the second anchoring part by continuous or discontinuous pre-cut lines.

The detachable part can also be in the form of a small transverse rectilinear bar separated from the second anchoring part and the intermediate part by pre-cut lines or tearable connecting strips. It can also have the form of a detachable part connected to the articulated part and the latching zone by two separable zones. The detachable part can also be in the form of a part having a recess of which the inner cutout corresponds to the outer cutout of the articulated part.

According to an alternative embodiment, said detachable part is in the form of a folding shutter having a separable zone, a folding part and a zone forming a hinge attached to the lateral surface of the endpiece, said folding part connecting said zone forming a hinge and one end of said articulated part, said sealable part being designed to be broken by forcing in said folding part, before said head is first used.

According to another alternative embodiment, said detachable part has a separable zone and a moveable part, said moveable part being connected to one end of said articulated part, said separable zone being designed to be broken by forcing in said moveable part in the direction of the endpiece, before said head is first used.

The detachable part consists for example of a strip separated from the articulated part and the second anchoring part by continuous or discontinuous pre-cut lines. Preferably, said detachable part is in the form of a tongue projecting from the side of the wall termed the “upper wall” of the cover. The detachable part can also be in the form of a small transverse rectilinear bar separated from the second anchoring part and the intermediate part by pre-cut lines or tearable connecting strips.

Advantageously, the first anchoring part and the second anchoring part and the articulated part each has an upper part, the plane of said upper part of said articulated part extending in a plane perpendicular to the demolding plane and said upper part of the second anchoring part extending in a plane defining, with the plane of said upper part of said articulated part, an angle of less than 180° turned toward the upper part of the dispensing head. Thus, the angle formed between the planes of the articulated part and the second anchoring part constitute a protruding angle which facilitates access to the articulated part and/or the detachable part when the dispensing head is open.

Preferably, said articulated part has additionally a closing skirt projecting from said cover in a direction termed the “longitudinal direction” away from the face termed the “upper face” of the cover, said closing skirt being designed to be received in said dispensing orifice. The closing skirt makes the dispensing orifice leakproof and constitutes a supplementary anchoring point for the cover on the endpiece, in the position termed the “closed position”.

Preferably, said upper part of the articulated part has a protuberance projecting close to the wall termed the “lateral wall” of said articulated part facing the second anchoring part. The protuberance makes it possible to engage, with one's nail for example, the articulated part so as to make it pivot.

According to a variant of the first embodiment, said articulated part additionally has a gripping means projecting from the side of the wall termed the “upper wall” of the cover. The gripping means enables the user to grasp the articulated part so as to pivot it in order to give free access to the dispensing orifice. The gripping means can for example be in the form of a ring which also allows the product dispenser to be stored suspended by said ring.

Advantageously, said endpiece has a peripheral covering skirt and a peripheral inner skirt, and each latching orifice is situated between said peripheral covering skirt and said inner peripheral skirt.

Advantageously the dispensing head has a secondary stop situated beyond said stop in the extension of the latching orifice of the endpiece, laterally to the outside of said latching orifice, said latching lug being able to unfold so as to become butted up against said secondary stop.

According to a second embodiment, said cover has an upper part forming a shoulder, a lower part defining the fastener, an intermediate part connecting said upper part and said fastener and a dispensing channel, and said latching orifice is in the form of a tubular sleeve in which said intermediate part of the cover slides longitudinally so that said shoulder or said fastener can butt up selectively against said tubular sleeve, said tubular sleeve having a traversing orifice able to come facing the dispensing channel in a position termed the “open position” and able to come facing the lateral wall of said intermediate part in a position termed the “closed position”.

Preferably, the internal diameter of said tubular sleeve is substantially equal to the external diameter of said intermediate part which slides in the tubular sleeve. Thus, the frictional forces between the inner wall of the tubular sleeve and the outer wall of the intermediate part are sufficiently high so as to hold the intermediate part longitudinally in position relative to the tubular sleeve in a position termed the “closed position” or “open position”.

According to a variant of the second embodiment, said cover has additionally a gripping means projecting from the side of the wall termed the “upper wall” of the cover.

In another advantageous embodiment of the invention, said cover has a lower part forming a fastener and an intermediate part positioned facing the upper wall of said latching orifice, and said latching orifice is in the form of a traversing slot in which said fastener is housed slidingly so that said intermediate part can selectively close and uncover the dispensing orifice.

The invention will be better understood, and other objectives, details, features and advantages thereof will become more clearly apparent during the following detailed explanatory description, of different embodiments of the invention given purely as illustrative and nonlimiting examples, with reference to the appended schematic drawings.

In these drawings:

FIG. 1 is a perspective view of a dispensing head according to a first embodiment of the invention;

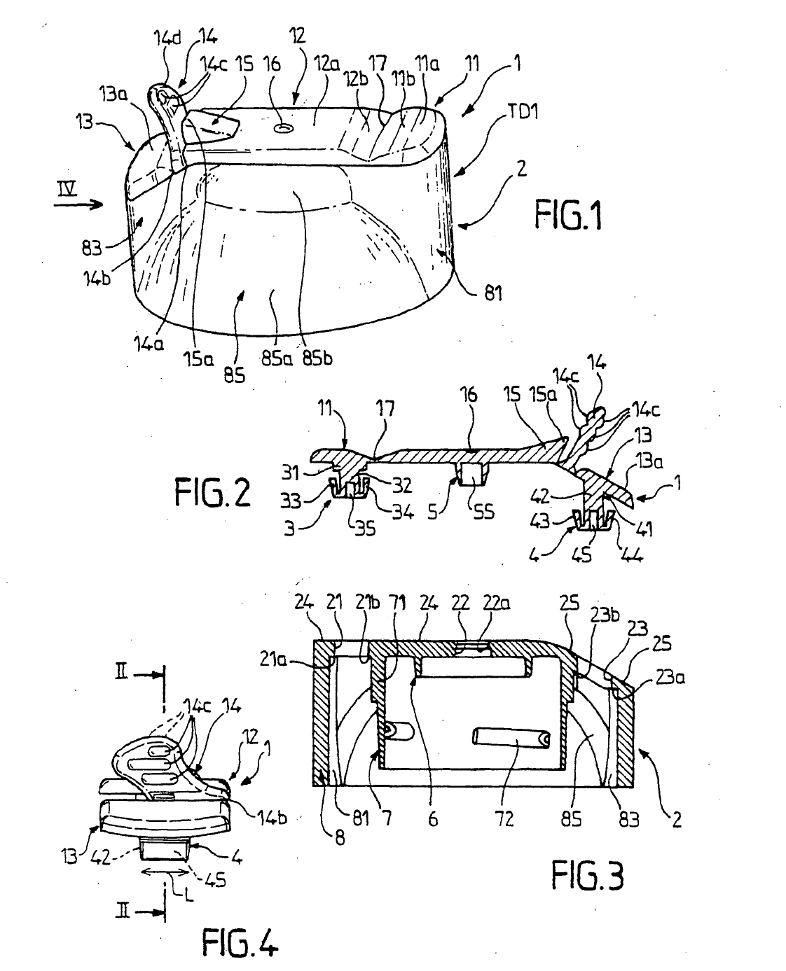

FIG. 2 is a longitudinal section of the cover along the line II-II of FIG. 4, namely along the demolding plane;

FIG. 3 is a longitudinal section along the demolding plane of the endpiece designed to fit together with the cover according to FIG. 2;

FIG. 4 is a side view of the cover indicated by the arrow IV of FIG. 1;

FIG. 5 is a perspective view from above of the endpiece designed to fit together with the cover according to FIGS. 2 or 6;

FIG. 6 is a perspective view of a dispensing head according to a second variant of the first embodiment of the invention;

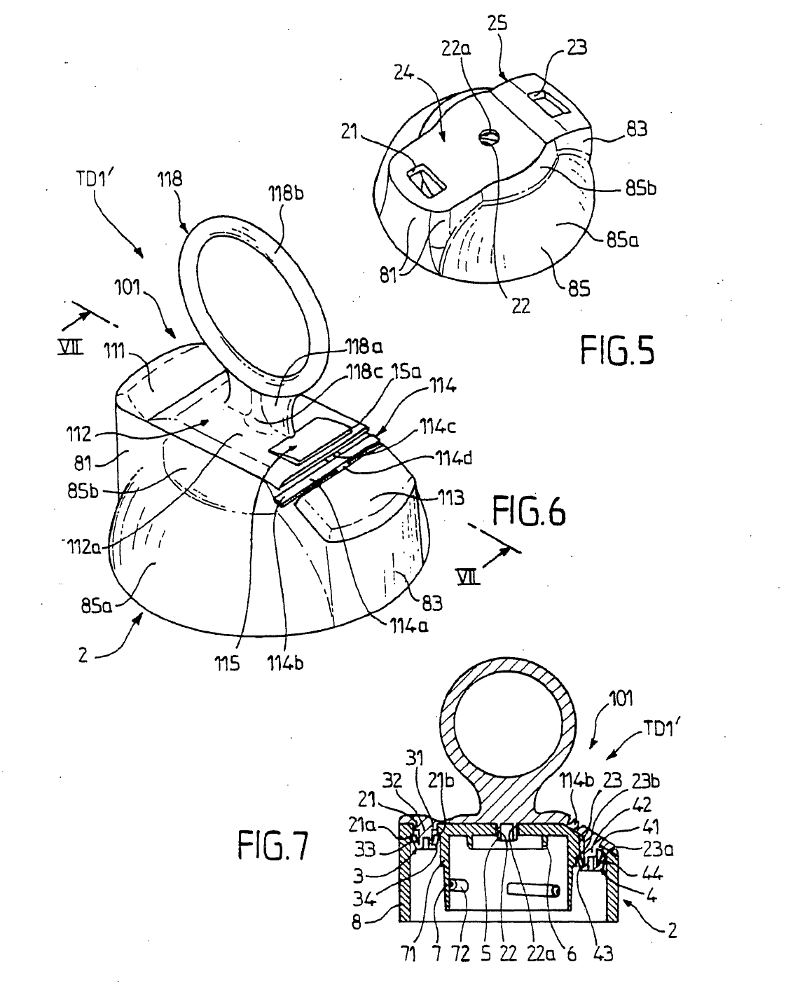

FIG. 7 is a longitudinal section of the dispensing head along the line VII-VII of FIG. 6, namely along the demolding plane;

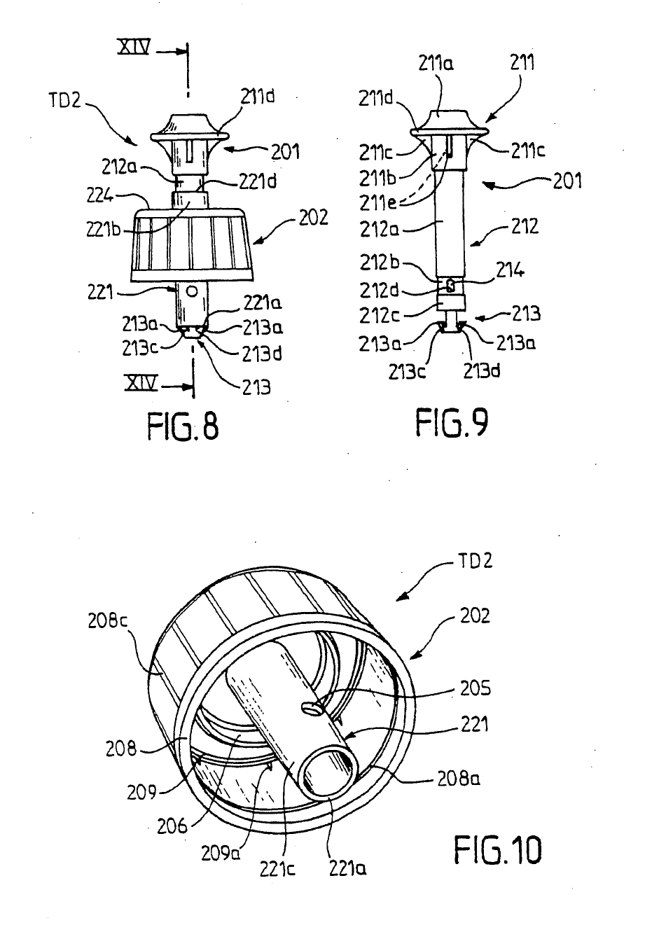

FIG. 8 is a view in elevation of a dispensing head according to a second embodiment of the invention in a position termed the “open position”;

FIG. 9 is a view in elevation of the cover of a dispensing head according to FIG. 8;

FIG. 10 is a perspective view from below of an endpiece of a dispensing head according to FIG. 8;

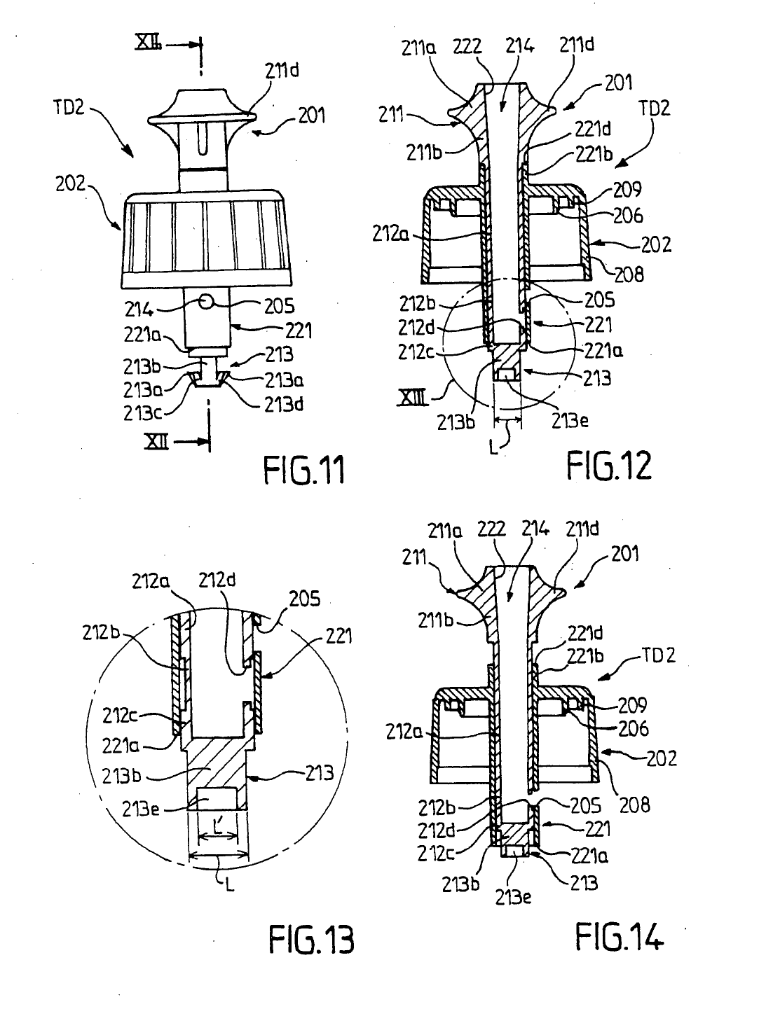

FIG. 11 is a view in elevation of a dispensing head according to FIG. 8, in a position termed the “closed position”;

FIG. 12 is a longitudinal section of the dispensing head along the line XII-XII of FIG. 11;

FIG. 13 is an enlarged view of the zone indicated by the arrow XIII of FIG. 12;

FIG. 14 is an enlarged longitudinal section of the dispensing head along the line XIV-XIV of FIG. 8;

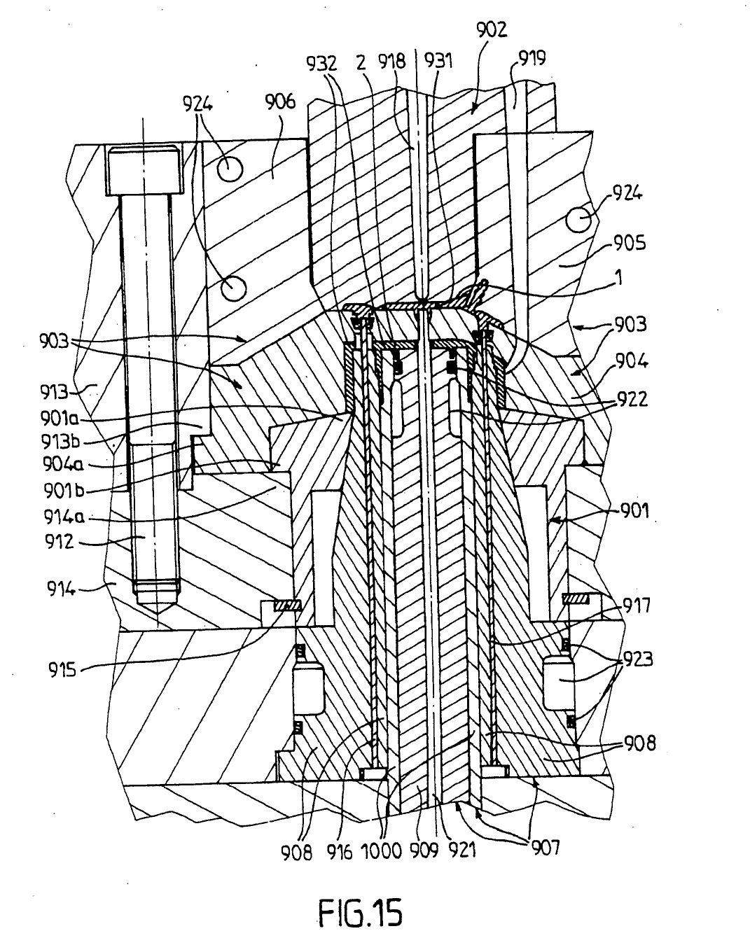

FIG. 15 is a partial longitudinal section of a molding device used for the method of the present invention;

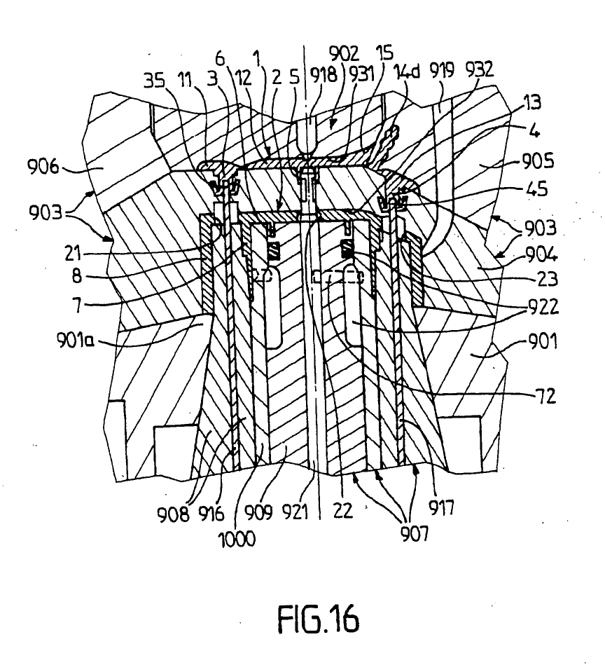

FIG. 16 is an enlarged view of the central zone of the molding device of FIG. 15;

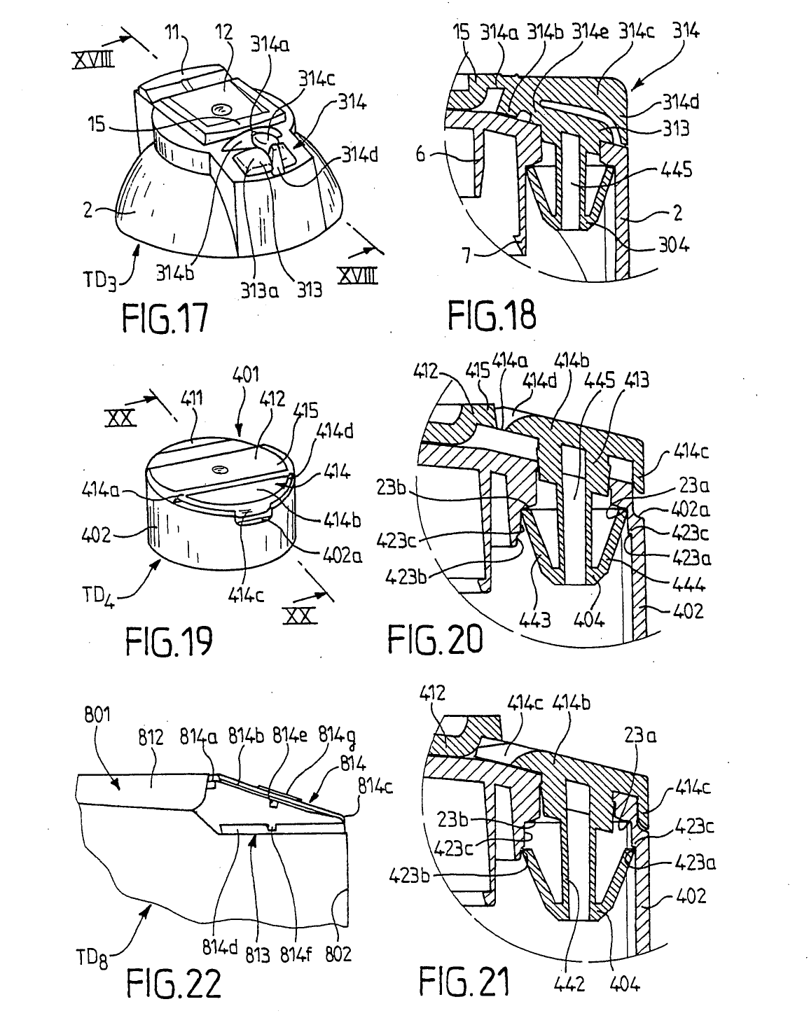

FIG. 17 is a perspective view for a dispenser according to a third variant of the first embodiment of the invention;

FIG. 18 is an enlarged view in longitudinal section of the dispensing head along the line XVIII-XVIII of FIG. 17, that is to say along its demolding plane, in the region of the tear-off part;

FIG. 19 is a perspective view of a dispensing head according to a fourth variant of the first embodiment of the invention;

FIG. 20 is an enlargement of a longitudinal section of the dispensing head along the line XX-XX of FIG. 19, that is to say along the demolding plane, in the region of the tear-off part, in the position termed the “position before first use”;

FIG. 21 is an identical view to FIG. 20, but in a position termed the “position after first use”;

FIG. 22 is a diagram illustrating a second embodiment of the tear-off part of a dispensing head according to the fourth variant of the first embodiment of the invention, in a position termed the “position before first use”;

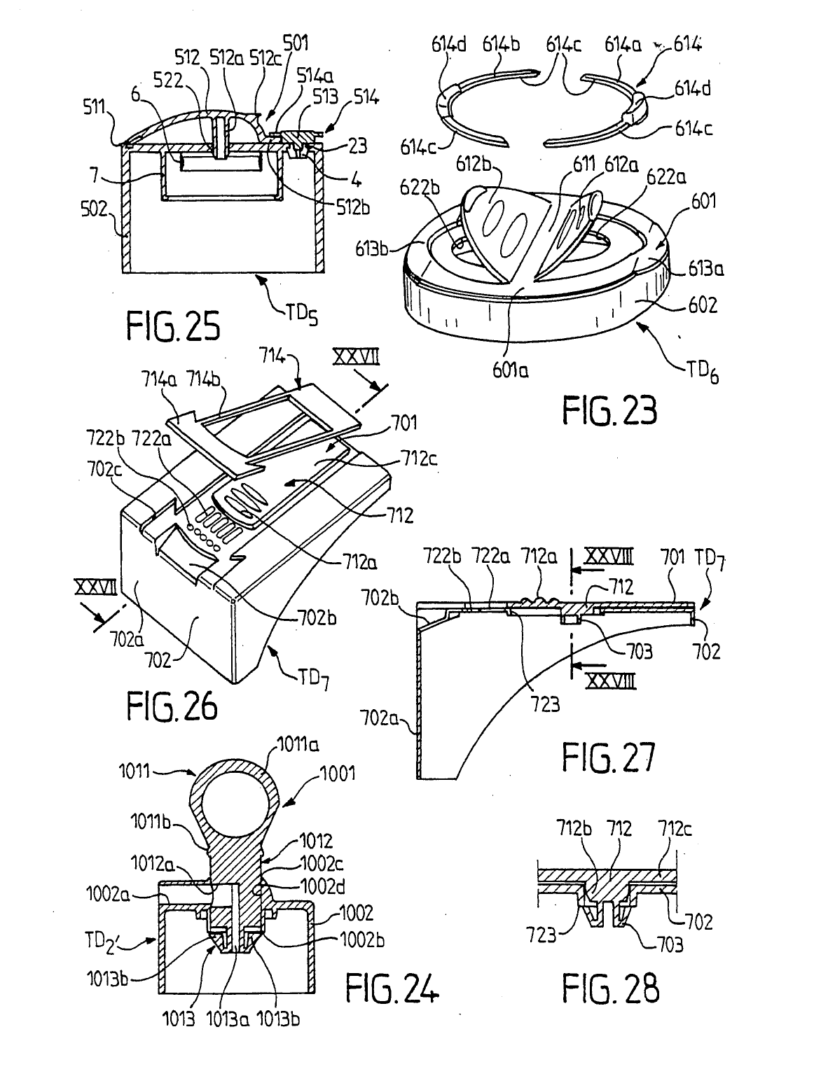

FIG. 23 is a perspective view of a dispensing head according to a fifth variant of the first embodiment of the invention in a position termed the “position after first use”;

FIG. 24 is a view in longitudinal section of the dispensing head according to a second variant of the second embodiment of the invention;

FIG. 25 is longitudinal section of a dispensing head according to a third embodiment of the invention, in a position termed the “position before first opening”;

FIG. 26 is a perspective view from above of a dispensing head according to a fourth embodiment of the invention, in a position termed the “position after first use”;

FIG. 27 is a longitudinal section of the dispensing head along the line XXVII-XXVII of FIG. 26; and

FIG. 28 is an enlarged sectional view along the line XXVIII-XXVIII of FIG. 27.

In the following detailed description, the vertical direction is termed “longitudinal” since this direction is parallel to the length of the receptacle carrying the dispensing head according to the invention. The plane termed the “demolding plane” is the middle plane of the dispensing head and of the fasteners which extend in the longitudinal direction. The lateral direction is the direction extending perpendicularly to the longitudinal direction in the demolding plane. The transverse direction is the direction perpendicular to the longitudinal and lateral directions. The expressions “longitudinal(ly)”, “lateral(ly)” and “transverse/transversely” will mean “in the longitudinal, lateral and transverse directions”. Finally, the plane of the cover is defined as the plane perpendicular to the longitudinal direction and passing through the upper part of the cover. In addition, the high or low positions of the elements described correspond hereinafter to the high or low positions of the figures.

FIG. 1 illustrates a first embodiment of a dispensing head TD1 in the position termed the “open position before first use”, designed to be placed at the top of a receptacle (not shown). The dispensing head TD1 comprises two distinct parts which are, longitudinally downward: the cover 1 and the endpiece 2.

The cover 1 has overall the form of a blade and comprises three parts, from one lateral end to the other: a first anchoring part 11, an articulated part 12 and a second anchoring part 13 of which only the upper parts 11a, 12a and 13a can be seen in FIG. 1. The upper parts of the first anchoring part 11a and of the articulated part 12a extend over the same plane while the upper part of the second anchoring part 13a extends over a plane inclined with respect to the plane of the upper part 12a of the articulated part 12.

The first anchoring part 11 and the articulated part 12 are separated by a part forming a hinge 17. The part forming a hinge 17, which is linear, extends transversely and is characterized, as can be seen in FIG. 2, by a longitudinal thickness less than the longitudinal thickness of the first anchoring part 11 and the articulated part 12. The lateral parts 11b and 12b of the first anchoring part 11 and of the articulated part 12 have respectively a thickness that decreases laterally in the direction of the part forming a hinge 17.

The second anchoring part 13 and the articulated part 12 are separated by a detachable part 14. The detachable part 14 is in the form of a tongue 14d which extends upward in a plane perpendicular to the plane of the upper part 13a of the second anchoring part 13. The tongue extends transversely in an inclined manner with respect to said longitudinal direction. The lateral parts of the detachable part 14 join the articulated part 12 and the second anchoring part 13 in two precut lines 14a and 14b respectively. The precut lines 14a and 14b are continuous and are characterized by a thickness, in the longitudinal direction, less than that of the part forming a hinge 17. According to FIG. 2, the upper and lower walls of the detachable part 14 have respectively two or three projecting ribs 14c.

The upper face of the articulated part 12 has, at its center, a central cup 16, and close to the lateral end facing the second anchoring part 13, a protuberance 15 with a rectangular section. The protuberance 15 has a thickness, in the longitudinal direction, that increases in the direction of the detachable part 14.

The upper edge 15a of the protuberance 15 projects slightly laterally in the direction of the second anchoring part 13.

From FIG. 2, each of the lower parts of the first and second anchoring parts 11 and 13 constitutes a fastener 3 and 4 respectively projecting from the plane of the cover 1.

The fastener 3 of the first anchoring part 11 has, longitudinally downwards and successively, a positioning collar 31 and a body 32 with a rectangular section. The positioning collar 31 extends in a plane parallel to that of the cover 1.

The lower part of the body 32 is extended into two flat rectangular latching lugs 33 and 34. Each latching lug 33 or 34 extends transversely in a plane inclined with respect to the longitudinal direction toward the plane of the cover 1. The latching lugs 33 and 34 are symmetrical with respect to the middle plane of the fastener perpendicular to the demolding plane. The body 32 is traversed longitudinally at its center by a recess 35 with a rectangular section emerging on the lower part of the fastener 3.

The fastener 4 of the second anchoring part 13 has, from FIG. 2, a structure that is substantially similar to that of the fastener 3 of the first anchoring part 11. In point of fact, the fastener 4 also extends in the longitudinal direction and has latching lugs 43 and 44 and a recess 45, similar to the latching lugs 33 and 34 and the recess 35 respectively. The body 42 of the fastener 4 differs from that of the fastener 3 in that it ends at its upper part in a positioning collar 41 which extends in a plane parallel to that of the upper part 13a of the second anchoring part 13.

From FIG. 4, the larger dimension L of the section of the body 42 of the fastener 4 is perpendicular to the demolding plane. The larger dimension of the section of the recess 45 (not visible in FIG. 4) is parallel to the dimension L.

The lower part of the articulated part 12 constitutes a closing skirt 5 projecting from the plane of the cover 1 as can be seen in FIG. 2.

The closing skirt 5 has a circular section. It is traversed longitudinally at its center by a recess 55 with a circular section emerging on the lower part of the closing skirt 5. The lateral wall of the closing skirt 5 has a diameter that decreases radially inwards.

From FIG. 3, the endpiece 2 has an upper part consisting of straight 24 and oblique 25 end walls (visible in FIG. 5) and a lower part defining three concentric skirts projecting downward from the end walls 24 and 25, which are, laterally outward, the sealing skirt 6, the inner peripheral skirt 7 and the peripheral covering skirt 8.

The latching orifices 21 and 23, aligned in the lateral direction, traverse longitudinally the straight end wall 24 and the oblique end wall 25 respectively and emerge between the peripheral covering skirt 8 and the inner peripheral skirt 7.

The dispensing orifice 22, situated substantially midway between the latching orifices 21 and 23, traverses the straight wall 24 longitudinally and emerges at the center of the sealing skirt 6.

The latching orifices 21 and 23 have flat inner walls and constitute shoulders, laterally toward the outside, 21a, 21b and 23a, 23b respectively, in the region of their lower part.

The dispensing orifice 22 has a radial narrowing in its upper part constituting a stop 22a.

The sealing skirt 6, the inner peripheral skirt 7 and the peripheral covering skirt 8 have a diameter and a longitudinal dimension that increase respectively. The sealing skirt 6 and the inner peripheral skirt 7 have a circular section and each has a constant diameter.

The inner peripheral skirt 7 has, in the upper part of its radially outer wall, a radially outer shoulder 71 and, in the region of its radially inner wall, a radially inner stop 72, that is discontinuous and helical, constituting a discontinuous thread. As a variant, the stop 72 may be circular and discontinuous or continuous, constituting a discontinuous or continuous thread.

The peripheral covering skirt 8 which constitutes the lateral wall of the endpiece 2, is composed of various portions, that can be seen in particular in FIG. 5, which are symmetrical with respect to the demolding plane: a first and second lateral portion 81 and 83, and a middle portion 85.

The middle portion 85 has a lower part 85a which has the form of a section of a sphere and of which the truncated top supports an upper part 85b having the general form of an annular bead.

The outer lateral wall of the first lateral portion 81 and of the second lateral portion 83 are perpendicular to the demolding plane and have a curvature in an arc of a circle in the extension of the curvature of the outer lateral walls of the first and second anchoring parts 11 and 13. The anterior and posterior walls of the first and second lateral portions 81 and 83 are parallel to each other and parallel to the demolding plane and are joined to the middle portion 85.

The alternative embodiment illustrated in FIGS. 6 and 7 differs from the embodiment previously described by the absence of the central cup 16 and by the presence of a gripping means 118 provided projecting from the upper wall of the articulated part 112 and a detachable part 114 which differs from the tongue 14d previously described. Identical structural elements carry the same reference as previously.

The gripping means 118 has the form of a ring 118b which extends in the demolding plane and is separated from the upper wall of the articulated part 112 by a flat base 118a flared out laterally in the direction of the ring 118b and the upper part 112a of the articulated part 112. A middle rib 118c reinforcing the base 118a is provided longitudinally on the anterior and posterior walls of the base 118a. One of the lateral ends of the base 118a joins the thinner lateral end of a protuberance 115.

The detachable part 114 is, in this alternative embodiment, in the form of a small rectilinear bar 114a which extends in the transverse direction. The small bar 114a is connected to the lateral walls of the articulated part 112 and of the second anchoring part 113 by tearable connecting strips 114c and 114d respectively of which the thickness and nature are equivalent to those of the precut lines 14a and 14b previously described. The small bar 114a extends transversely over all the transverse length of the articulated part 112. The small bar 114a is asymmetrical with respect to the demolding plane, only projecting from the anterior side of the cover 101 and in this way constituting a grip 114b.

FIG. 7 illustrates the dispensing head TD1′, according to the variant of the first embodiment previously described, assembled before it is first used. The parts involved in assembly are only parts common to the first embodiment and its variant. Consequently, the assembly of the dispensing head TD1′ described hereinafter is equivalent to that of the dispensing head TD1.

From FIG. 7, the cover 101 is fitted together with the endpiece 2 by snap-fastening the fasteners 3 and 4 into the latching orifices 21 and 23 respectively. When they pass into the latching orifices 21 and 23 of the detent, the latching lugs 33, 34 and 43, 44 fold back longitudinally against the body 32 and 42 of the fasteners 3 and 4 respectively. After passing into the latching orifices 21 and 23, the latching lugs 33, 34 and 43, 44 fold back and their upper wall is butted against the shoulders 21a, 21b and 23a, 23b respectively, making it impossible in this way to withdraw the fasteners 3 and 4 from the latching orifices 21 and 23.

During assembly, the closing skirt 5 of the cover 101 is inserted into the dispensing orifice 22 of the endpiece 2. The stop 22a cooperates with the lateral wall of the closing skirt 5 so as to provide satisfactory impermeability in the region of the dispensing orifice 22.

Similarly, the positioning collars 31 and 41 of the fasteners 3 and 4 respectively cooperate with the inner wall of the latching orifices 21 and 23 so as to provide satisfactory positioning in the region of the latching orifices 21 and 23 of the cover 101 relative to the endpiece 2.

Assembly of the dispensing head TD1′ onto a receptacle containing the product to be dispensed (not shown) is carried out by making the stop 72 of the inner peripheral skirt 7 cooperate with the external thread of a wall delimiting the opening of the receptacle, in the case of assembly by screwing the dispenser head TD1′ onto the receptacle. It is obvious that the stop 72 could equally cooperate with radial grooves or stops provided in the region of the inner wall delimiting the opening of the receptacle, in the case of assembly by detenting the dispensing head TD1′ and the receptacle together. Impermeability between the dispensing head TD1′ and the receptacle is then achieved by cooperation of the outer wall of the sealing skirt 6 with the inner face of the wall delimiting the opening of the receptacle. Assembly by screwing makes it possible for the user to recharge the receptacle having a dispensing head TD1′ with the product to be dispensed. Assembly by detenting, together with the presence of a tamper-evident seal constitutes, for the user, a proof, before its first use, of the integrity of the contents of the receptacle having a dispensing head TD1′.

Finally, the shape of the peripheral covering skirt 8 makes it possible to mask harmoniously the internal elements of the dispensing head TD1′ ensuring latching and impermeability while being adapted to the general shape of the receptacle.

When the dispensing head TD1 or TD1′ is first used, the user grasps the tongue 14d which is made easier to hold by the presence of projecting ribs 14c, or grasps the small bar 114a by the grip 114b and tears off the tongue 14d or the small bar 114a by tearing along the pre-cut lines 14a and 14b or tearable connecting strips 114c and 114d respectively. The tongue 14d or the small bar 114a constitutes in this way a tamper-evident seal.

The user then latches on the cover 1 or 101 by the upper edge 15a projecting from the protuberance 15 or 115, or even the grasping means 118, in order to pivot the articulated part 12 or 112 and to release the dispensing orifice 22 so as to enable to product to be dispensed.

After dispensing, the user pivots the articulated part 12 so as to apply it against the upper face of the endpiece 2. Simultaneously, the covering skirt 5 is reintroduced into the dispensing orifice 22. The fact that the diameter of the covering skirt 5 decreases radially inwards makes it easier to withdraw and reinsert the covering skirt 5 in relation to the dispensing orifice 22.

The alternative embodiments illustrated in FIGS. 17 to 22 differ from the embodiment previously described by a different configuration of the detachable part.

Identical structural elements carry the same references as previously.

FIGS. 17 and 18 illustrate a third variant of the first embodiment of the invention.

In this embodiment, the dispensing head TD3 has a fastener 304 in the region of the second latching zone 314 which is identical to the fastener 4 previously described, except for the upper surface 313a of the second latching zone 313 which is substantially flat and rectangular and which extends in a plane perpendicular to the demolding plane.

The dispensing head TD3 has an articulated part 12 which is overall in the form of a tongue projecting from the upper wall of the cover 301 and extending in the demolding plane. The articulated part 12 is connected to the second anchoring part 313 by a detachable part 314. The detachable part 314 is composed of five zones: a first and a second separable zone 314a and 314e respectively, a first and second intermediate zone 314b and 314c respectively, and a latching zone 314d. The first intermediate zone 314b connects the first separable zone 314a and the second separable zone 314e. The second intermediate zone 314c connects the second separable zone 314e and the latching zone 314d.

The separable zones 314a and 314e consist of a tearable film or of a pre-cut line.

Before the dispensing head TD3 is used for the first time, the user grasps the latching zone 314d and raises it upward, which enables the second separable zone 314e to give. Then, the first intermediate zone 314b is raised by the action of the user, which causes the first separable zone 314a to break. After the first and second separable zones 314a and 314e break, the detachable part 314 is completely detached from the dispensing head TD3 and can be discarded by the user. The detachable part 314 then consists of zones 314b, 314c and 314d which remain secured after the detachable part 314 has been torn off. When the detachable part 314 is discarded, the second anchoring zone 313, of which the upper surface 313a is laid bare, remains anchored to the surface of the endpiece 402, which enables the impermeability of the system to be preserved.

The articulated part 12 has a free end protuberance 15. The user can then grasp the end protuberance 15 in order to pivot the articulated part 12 so as to give free access to the dispensing orifice (not shown in FIG. 17) so as to dispense the product contained in the dispenser (not shown) onto which the dispensing head TD3 is fixed.

FIGS. 19 to 21 illustrate a fourth variant of the first embodiment wherein the detachable part 414 is forced in a longitudinal direction into the endpiece 402 after it is first used.

The dispensing head TD4 has a cylindrical endpiece 402 with a circular section and constant diameter. The endpiece 402 has a notch 402a with a concave shape of which the concavity is turned in the direction of the cover 401, the notch 402a being positioned in the region of the upper part of the endpiece 402.

The cover 401 consists of a first and second anchoring part 411 and 413 respectively.

In this embodiment, the fastener 404 of the anchoring zone 413 differs from the fastener 4 previously described by the fact that it has a body 442 that is more extended in the longitudinal direction than the body 42 of the fastener 4 previously described. In addition, the latching lugs 443 and 444 of the fastener 404 cooperate with two different types of stop: primary stops 23a, 23b and secondary stops 423a, 423b. The secondary stops 423a, 423b are shoulder faces which have a lateral extension greater than that of the primary stops 23a, 23b. The primary stops 23a, 23b and secondary stops 423a, 423b are separated by a cylindrical or conical section 423c. From FIG. 20, the wings 443 and 444 are in contact with the primary stops 23a and 23b before the dispensing head TD4 is first used.

The first and second anchoring parts 411 and 413 are connected by an articulated part 412. The first and second anchoring parts 411 and 413 and the articulated part 412 extend over all the upper surface of the endpiece 402.

The detachable part 414 consists of a separable zone 414a, of an intermediate part 414b, of a guiding miter 414c and of a peripheral bead 414d. Contrary to the detachable parts previously described, the detachable part 414 is not torn off but is forced into the endpiece 402. The guiding miter 414c is positioned at the end of the second anchoring part 413 opposite the separable zone 414a. The separable zone 414a and the guiding miter 414c are separated by the intermediate zone 414b. The guiding miter 414c has overall the form of a tongue of which the outer cutout is complementary to that of the notch 402a. The guiding miter 414c extends longitudinally in the direction of the endpiece 402 facing the notch 402a. It is extended in its upper part by a peripheral bead 414d which defines the lateral end surface of the intermediate zone 414b
At the time of first use, the user forces the detachable part 414 in the direction of the endpiece 402, which causes the separable zone 414a to break.

When the fastener 404 is forced in by pressure, the wings 443 and 444 slide along the section 423c. Once they have arrived in the region of the secondary stops 423a and 423b, the wings 443 and 444 unfold. From FIG. 20, the upper wall of the wings 443 and 444 then come into contact with the secondary stops 423a and 423b. Forcing in the fastener 404 is accompanied by simultaneous forcing in of the guiding miter 414c into the notch 402 of the endpiece 402. As a variant, it is possible to provide primary stops 23a, 23b and secondary stops 423a, 423b possessing the same lateral extension and a narrowing of the orifice of the endpiece in the region situated between the primary stops 23a, 23b and secondary stops 423a, 423b.

FIG. 22 shows schematically an alternative embodiment wherein the dispensing head TD8 has an endpiece 802 and a cover 801 consisting of a first anchoring part (not shown), an articulated part 812, a second anchoring part 813 (not shown) and a detachable part 814. Contrary to the detachable parts previously described, the detachable part 814 is in the form of a foldable shutter which is not torn away but folds back in the direction of the upper surface of the endpiece 802.

The detachable part 814 consists of a fixed zone 814d fixed to the upper surface of the endpiece 802 by a second anchoring part 813 that can be a fastener similar to the fasteners previously described or any other fixing means (adhesion, etc.). The detachable part 814 additionally has a folding zone 814b, a separable zone 814a connecting the end surface of the articulated part 812 and the folding zone 814b, and a hinge zone 814c connecting the fixed zone 814d to the folding zone 814b. In addition, the folding zone 814b can have a latching means 814e at the center of its lower wall designed to cooperate with a latching orifice 814f situated at the center of the upper wall of the fixed zone 814d. The latching means can be any latching means, such as a bead or a latching fastener such as defined in the above description or alternatively a latching fastener having non-folding wings or wings that are secured to the body of the fastener. Finally, the upper wall of the folding zone 814b can be provided with illustrations in relief 814g which can preferably be letters, for example the word “press”. Other illustrations, in relief or not, can also be provided in all the dispensing heads within the context of the present invention.

At the time of first use, the user will apply pressure to the folding zone 814b, which will break the separable zone 814a and fold the folding zone 814b along the axis of the hinge zone 814c which is perpendicular to the demolding plane. Pressure by the user will also enable the latching means 814e and the latching orifice 814f to be assembled. It should be understood that the latching orifice 814f and the latching means 814e are optional since the fixed zone 814d closes the endpiece 802 impermeably. Thus, association of the folding zone 814b and the fixed zone 814d is not indispensable for maintaining the impermeability of the system. This assembly simply has the aim of preventing the folding zone 814b from being torn off accidentally by the user, which could cause the fixed zone 814d, which is secured to the folding zone 814b, to be torn away, which could then compromise the impermeability of the system.

FIG. 23 illustrates a fifth variant of the first embodiment of a dispensing head TD6 wherein the endpiece 602 also has a constant circular section but has two dispensing orifices 622a and 622b, preferably with different diameters and/or shapes.

The cover 601 has, in this case, a single first anchoring part 611 (not visible in the figure) and two second anchoring parts 613a and 613b (also not visible in the figure) of which at least one of the second anchoring parts 613a and 613b is a fastener as previously described. The cover 601 additionally has two articulated parts 612a and 612b positioned between the first anchoring part 611 and the second anchoring parts 613a and 613b respectively. The two articulated parts 612a and 612b are radially surrounded with a peripheral ring 601a connecting the first anchoring part 611 to the second anchoring parts 613a and 613b. The peripheral ring 601a establishes a continuity of the upper wall of the cover 601 with the upper surface of the articulated parts 612a and 612b for reasons of ergonomic order.

The detachable part 614 is formed of a first and second identical tear-off tongue 614a and 614b that have a semi-circular shape. The first and second tear-off tongues 614a and 614b have lateral separable zones 614c. They are positioned facing each other and separate the laterally outer surface of the articulated parts 612a and 612b and the laterally inner surface of the peripheral ring 601a by lateral separable zones 614c. In addition, the tear-off tongues 614a and 614b have a latching miter 614d in the region of their upper surface.

Before first use, the user grasps each miter 614d which makes it possible to break the separable zones 614c. When the separable zones 614c are broken, the tear-off tongues 614a and 614b can be removed from the dispensing head TD6. The articulated parts 612a and 612b can then pivot so as to give free access to the dispensing orifice 622a or 622b for dispensing the product contained in the receptacle (not shown) carrying the dispensing head TD6.

According to other alternative embodiments, the endpiece can be provided in the region of its lower wall with detenting beads or fasteners defined in the description above so as to cooperate with the upper wall of a third part having respectively a detenting groove or a latching orifice of the fastener. This third part can be a receptacle, or an intermediate part between the endpiece and the receptacle.

Finally, the articulated part can be positioned perpendicular to the demolding plane with the first and second anchoring parts positioned in the demolding plane.

FIGS. 8 to 14 illustrate a second embodiment of the dispensing head according to the invention.

From FIG. 8, the dispensing head TD2 comprises two distinct parts: a cover 201 and an endpiece 202. The cover 201, from FIG. 9, has overall a cylindrical shape with a circular section and consists of various parts: an upper part forming a shoulder 211, an intermediate part 212, a lower part defining a fastener 213, and a dispensing channel 214 of which only the lower end emerging in the region of the oblong hole 212d is visible in FIG. 9.

The shoulder 211 has an upper portion 211a and a lower portion 211b separated by an outer radial bead 211d.

The upper portion 211a is flared out and its diameter increases radially in the direction of the outer radial bead 211d.

The lower portion 211b is tubular overall, and has a circular section and constant diameter. Supporting wings 211c and 211e connect the outer wall of the lower portion 211b to the lateral wall of the radially outer bead 211d. Each pair of supporting wings 211c or 211e has two diametrically opposed wings. The pair of wings 211c is positioned perpendicularly to the demolding plane and the pair of wings 211e is positioned in the demolding plane.

The intermediate part 212 is composed of three portions: an upper portion 212a, an intermediate portion 212b and a lower portion 212c that are cylindrical overall and have a circular section. The upper portion 212a and the lower portion 212c have an equivalent diameter, less than the diameter of the lower portion 211b of the shoulder 211. The intermediate portion 212b of the intermediate part 212 has an external diameter less than the external diameter of the upper portion 212a and of the lower portion 212c of the intermediate part 212. A traversing oblong hole 212d is provided in the wall of the intermediate portion 212b in the demolding plane.

The fastener 213 differs from the fasteners 3 and 4 of the embodiment previously described only by the presence of stop wings 213a positioned in a middle plane of the fastener perpendicular to the demolding plane. The fastener 213 has a body 213b with a rectangular section. The lower part of the body 213b is extended in two flat rectangular latching lugs 213c and 213d. Each latching lug 213c or 213d extends transversely in a plane inclined with respect to the longitudinal direction toward the plane of the lower part of the lower portion 212c. The latching lugs 213c and 213d are symmetrical with respect to the middle plane of the fastener perpendicular to the demolding plane. The body 213b is traversed longitudinally in its center by a recess 213e that can be seen in FIGS. 12 to 14. The recess 213e has a rectangular section and emerges on the lower part of the fastener 213. From FIGS. 12 and 13, the larger dimension L of the section of the body 213b of the fastener 213 is perpendicular to the demolding plane. The larger dimension L′ of the section of the recess 213e, that can be seen in FIG. 13, is parallel to the dimension L. From FIG. 11, the pair of stop wings 213a projecting from the outer wall of the latching lugs 213c and 213d, extends in the middle plane of the fastener 213 which is perpendicular to the demolding plane. The stop wings 213a have the same height as that of the latching lugs 213c and 213d so that their upper face constitutes a single reinforced stop jointly with the upper face of the latching lugs 213c and 213d.

As illustrated in particular in FIGS. 12 and 14, the dispensing channel 214 extends vertically, successively from the oblong hole 212d to the lower portion 212c, the intermediate portion 212b and the upper portion 212a of the intermediate part 212 and then traverses the shoulder 211 and emerges in the region of the dispensing orifice 222.

From FIG. 8, the endpiece 202 has an upper part consisting of an end wall 224 and the upper part 221b of a tubular sleeve 221 projecting from the end wall 224.

The upper face of the upper part 221b of the tubular sleeve 221 constitutes a circular stop 221d.

From FIG. 10, the endpiece 202 also has a lower part defining three elements projecting downwards from the end wall 224 which are, successively outwards: the lower part 221c of the tubular sleeve 221 which defines the latching orifice of the fastener 213, a sealing skirt 206, a shorter inner peripheral skirt 209, and a peripheral covering skirt 208 defining the lateral wall of the endpiece 202.

The tubular sleeve 221 has a circular section and a height greater than that of the peripheral covering skirt 208. The tubular sleeve 221 extends along the axis of rotation of the dispensing head TD2. The internal diameter of the tubular sleeve 221 is substantially equal to the external diameter of the intermediate part 212 of the cover 201.

The lower face of the lower part 221c of the tubular sleeve 221 constitutes a circular stop 221a.

The sealing skirt 206 and the peripheral covering skirt 208, that have a circular section, are coaxial with the tubular sleeve 221 and have a diameter greater than that of the tubular sleeve 221.

The sealing skirt 206 has a round traversing orifice 205 in the demolding plane.

The inner peripheral skirt 209 is reinforced laterally by reinforcing wings 209a.

The peripheral covering skirt 208 defining the outer wall of the dispensing head TD2 has, in the region of its inner wall, in the lower part, a radially inner shoulder 208a. Longitudinal gripping serrations 208c are provided in the region of the side wall of the covering skirt 208.

FIGS. 8 and 14 illustrate the dispensing head TD2 in the position termed the “open position”. FIGS. 11, 12 and 13 illustrate the dispensing head TD2 in a position termed the “closed position”.

The cover 201 is force-fitted onto the endpiece 202 by detenting the fastener 213 into the tubular sleeve 221 acting as a latching orifice. When they pass into the tubular sleeve 221, the latching lugs 213c and 213d and the stop wings 213a fold back longitudinally along the body 213b. After passing into the tubular sleeve 221, the latching lugs 213c and 213d and the stop wings 213a fold back and the upper face of the latching lugs 213c and 213d butt up, in the open position, as illustrated in particular in FIG. 8, against the circular stop 221a of the endpiece 202, in this way making it impossible to withdraw the fastener 213 from the tubular sleeve 221. The stop wings 213a consolidate the support of the upper part of the latching lugs 213c and 213d against the circular stop 221a.

Assembly of the dispensing head TD2 onto a receptacle containing the product to be dispensed (not shown) is carried out by inserting by force the wall delimiting the opening of the receptacle (not shown) between the outer wall of the sealing skirt 206 and the inner peripheral skirt 209. It is obvious that the dispensing head TD2 could be assembled onto the receptacle by screwing or detenting. The wall of the sealing skirt 206 or the inner peripheral skirt 209 would then, according to the case, be fitted with a thread or a circular stop. Impermeability between the dispensing head TD2 and the receptacle is equally achieved by cooperation between the outer face of the sealing skirt 206 and the inner face of the wall delimiting the opening of the receptacle.

When the dispensing head TD2 is used, the user latches on the shoulder 221 by the radially outer bead 211d and pulls the cover 201 vertically upward so as to pass from the position termed the “closed position” to the position termed the “open position”. In the position termed the “closed position”, illustrated in particular in FIG. 12, the lower face of the shoulder 211 butts up against the circular stop 221d. In this position, the round orifice 205 of the tubular sleeve 221 and the oblong hole 212d of the intermediate part 212 are offset longitudinally from each other. The dispensing channel 214 emerges, in this position, on the inner wall of the tubular sleeve 221.

In the position termed the “open position”, illustrated in particular in FIG. 14, the upper part of the stop wings 213a and the latching lugs 213c and 213d butt up against the circular stop 221a of the tubular sleeve 221. In this position, the round orifice 205 of the tubular sleeve 221 is positioned facing the oblong hole 212d of the intermediate part 212 of the cover 211. Thus, in the open position, the product contained in the receptacle can flow freely outwards from the receptacle, through the dispensing channel 214, crossing successively the round orifice 205 of the tubular sleeve 221, the oblong hole 212d of the intermediate part 212 of the cover 201, the intermediate part 212 of the cover 201 and the dispensing orifice 222.

Longitudinal locking in the position termed the “open position” or in the position termed the “closed position” occurs naturally due to the frictional forces that are exerted between the tubular sleeve 221 and the intermediate part 212 of the cover 201. It is obvious that the inner wall of the tubular sleeve 221 and the outer wall of the intermediate part 212 of the cover 201 could be provided with stops or ribs cooperating in order to lock longitudinally the positioning of the tubular sleeve 221 and the outer wall of the intermediate part 212 in the position termed the “closed or open” position.

FIG. 24 illustrates a variant of the second embodiment of the invention. All the elements identical to those of the second embodiment will not be described again. The dispensing head TD2′ has an endpiece 1002 with a constant circular section at the center of which the cover 1001 slides. The upper wall of the endpiece 1002 has an orifice 1002d in the form of a tubular sleeve delimited by an upper stop wall 1002c and a lower stop part 1002b. The endpiece 1002 also has a horizontal dispensing channel 1002a emerging outwards.

The cover 1001 has an upper part 1011, a lower part forming a fastener 1013 and an intermediate part 1012 separating the upper part 1011 from the fastener 1013.

The upper part 1011 has a gripping means 1011a with an annular shape of which the lower part is delimited by a bead 1101b.

The intermediate part 1012 has a dispensing channel 1012a with the same diameter as the dispensing channel 1002a of the endpiece. The dispensing channel 1012a extends linearly and radially outwards from the cover 1001. It emerges by its outer end in the dispensing channel 1002.

The fastener 1013 has latching lugs 1013b and a dispensing channel 1013a. The dispensing channel 1013a is vertical and emerges on the one hand in the inner end of the dispensing channel 1012a of the intermediate part 1012 and on the other hand outwards via the center of the fastener 1013.

During use, the user grasps the gripping means 1011a and pulls the endpiece 1011 vertically so as to cause the upper wall of the latching lugs 1013b of the fastener 1013 to butt up against the lower part 1012b of the latching orifice. In this way, the dispensing channels 1002a of the endpiece 1002 and 1012a of the cover 1001 are positioned facing each other. The product can then flow freely outwards. After use, the user pushes back the cover 1001 vertically until the bead 1011b butts up against the upper stop wall 1002c of the endpiece 1002. Thus, in this position, the dispensing channel 1002a of the endpiece 1002 is closed by the radially outer surface of the part included between the annular bead 1011b and the dispensing channel 1012a of the cover 1011. The product can then no longer flow outwards.

FIG. 25 illustrates a third embodiment of the dispensing head TD5 wherein the endpiece 502 is molded in a single part with the articulated part 512 of the cover 501. In addition, the second anchoring part 513 of the cover 501 is independent of the articulated part 512. The articulated part 512 has a latching projection 512b positioned in the region of its upper part facing the second anchoring part 513. The articulated part 512 additionally includes an end portion 512b positioned in the region of its lower peripheral portion.

The first anchoring part 511 has, in this embodiment, the form of a film hinge connecting the articulated part 512 to the lateral surface of the endpiece 502. The articulated part 512 has a sealing cylinder 512a which extends vertically from the center of the lower wall of the articulated part 512 in the direction of the center of the upper wall of the endpiece 502. The upper wall of the endpiece 502 has a dispensing orifice 522 capable of receiving the sealing cylinder 512a previously described.

The second anchoring part 413 has, in the region of its upper peripheral wall, a collar 514 extending radially outwards.

When a dispensing head TD5 is produced according to this embodiment, the endpiece 502 and the articulated part 512, as well as the first anchoring part 511 forming a hinge, are molded in a first molding cavity. The second anchoring part 513 which has a fastener 4 in the region of its lower end, is molded in a second molding cavity.

After molding, assembly of the parts incorporates a supplementary step prior to the step consisting of assembling the fastener 4 of the second anchoring part 513 into the latching orifice 23 of the endpiece 502. This step consists of folding the intermediate part 512 back onto the upper wall of the endpiece 502 by pivoting about the axis formed by the hinge formed by the first anchoring part 511, which makes it possible for the sealing cylinder 512a to cooperate in the dispensing orifice 522. Assembly then proceeds by anchoring the second anchoring part 513, which consists of inserting the fastener 4 into the latching orifice 23. The articulated part 512 is held supported against the upper wall of the endpiece 502 by cooperation of the collar 514 with the end portion 512b of the intermediate part 512.

Before first use, the user grasps the latching projection 512c which is provided in the region of the upper wall of the articulated part 512 facing the second anchoring part 513. The user then pivots the intermediate part 512 about the axis defined by the first anchoring part 511 forming a hinge. This pivoting is only made possible by forcing the end portion 512b of the articulated part 512 beyond the second anchoring part 513. Movement of the end portion 512b beyond the second anchoring part 513 involves deformation, or even rupture, of the inner portion 514a of the detachable part 514. After the end portion 512b of the inner portion 514a of the collar 514 has passed, the articulated part 512 can pivot and give free access to the dispensing orifice 522. After use, the user can fold back the articulated part against the upper wall of the endpiece 502. The articulated part 512 is held folded back by cooperation of the sealing cylinder 512a in the dispensing orifice 522.

FIGS. 26 to 28 illustrate a fourth embodiment wherein the fastener 703 slides in the lateral direction in the latching orifice 723. The dispensing head TD7 according to this embodiment, consists of an endpiece 702 and a cover 701 sliding by means of a single anchoring part 712 in a dispensing orifice 723. The endpiece 702 has overall a parallelepiped shape of which the large base 702a is, hereinafter, termed the “outer lateral surface” of the endpiece 702. The endpiece 702 has, in the region of its upper surface, a surface recess 702c hollowed out in the form of a channel extending in the lateral direction over all the length of the endpiece 702 in the region of its middle part. The dispensing orifice 723 is hollowed out longitudinally at the center of the surface recess 702c. The endpiece 702 has two different types of dispensing orifice: pouring orifices 722a which enable a large amount of the product to be dispensed, and sprinkling orifices 722b which enable a more limited amount of the product to be dispensed. The pouring orifices 722a have an elongated shape. They are hollowed out in the surface recess 702c in a parallel manner and are positioned in a row perpendicular to the demolding plane, between the dispensing orifice and the outer lateral surface 702a of the endpiece 702. The sprinkling orifices 722b have a rounded shape. They are hollowed out in the surface recess 702c and are positioned in a row perpendicular to the demolding plane, between the pouring orifices 722a and the outer lateral surface 702a of the endpiece 702. The endpiece also has a notch 702b positioned facing the row of sprinkling orifices 722b between said sprinkling orifices 722b and the outer lateral surface 702a. The endpiece 702 has a latching orifice 723 which is slot-shaped (only visible in FIGS. 27 and 28).

The cover 701 is in the form of a tongue with overall a rectangular shape which only has a single movable anchoring part 712. The anchoring part 712 has an upper part 712c which extends, via an intermediate part 712b into a lower part forming a fastener 703.

The upper wall of the upper part 712c is provided with means of adhesion 712a positioned in a parallel line in a direction perpendicular to the demolding plane so as to offer satisfactory grip to the finger of a user in order to slide the cover 701.

The intermediate part 712b of the anchoring part 712 has a length less than that of the latching orifice 723. This characteristic enables the cover 701 to slide longitudinally within the latching orifice 723. In addition, the intermediate part 712b of the anchoring part 712 has a width close to the width of the latching orifice 723. This feature means that the cover 701 can slide in the latching orifice 723 without any play between the parts.

The endpiece 701 is also provided with a detachable part 714 with overall a rectangular shape comprising a central orifice 714b of which the shape matches that of the cutout of the upper wall 712c of the anchoring part 712. The detachable part 714 has an outer cutout of which the shape corresponds to that of the surface recess 702c hollowed out on the upper surface of the endpiece 702. This feature enables the cover 701 to be immobilized in the dispensing head TD7. The end portion of the detachable part 714 toward the lateral surface 702a of the endpiece 702 facing the notch 702b is provided with a latching miter 714a.

Before first use, the user grasps the latching miter 714a of the detachable part 714 by positioning his or her nail between the miter 714a and the notch 702b, and tears off the tearable part 714b which surrounds the only anchoring part 712. The cover 701 is no longer attached to the upper surface of the endpiece 702 and can slide freely in a direction parallel to that of the demolding plane. The user then slides the anchoring part 712 parallel to the demolding plane, in a direction away from that of the outer lateral surface 702a in order to give free access only to the sprinkling orifices 722b or at the same time to the sprinkling orifices 722b and the pouring orifices 722a according to the desired flow of product dispensed. After use, the user pushes back the anchoring part 712 facing the outer lateral surface 702a so as to close successively the pouring orifices 722a and the sprinkling orifices 722b.

The detachable parts 14, 114, 314, 414, 514, 614, 714 and 814 constitute tamper-evident seals of the dispensing heads and can have structural variants while falling within the scope of the present invention. In addition, they can be reattached to a zone of the dispensing head not having any fastener.

FIG. 15 illustrates the arrangement termed the “molding arrangement” for the various elements making up the molding device. In the following description, only the elements that are spatially close to the molding cavities will be described. The molding device comprises three different groups of elements which define two distinct molding cavities: the molding cavity 931 in which the cover 1 is molded and the molding cavity 932 in which the endpiece 2 is molded. The molding cavities 931 and 932 are superimposed longitudinally and each molding cavity 931 and 932 is symmetrical with respect to the demolding plane.

The three groups of molding elements are, successively downwards, the upper molding core 902 positioned above the slide mold 903 which is composed of two parts that are symmetrical with respect to the demolding plane of which only the rear part is visible in FIGS. 15 and 16, and a lower molding core 907 that is itself positioned below the slide mold 903.

The upper molding core 902 is detachable vertically relative to the subjacent slide mold 903.

The rear part of the slide mold 903 consists of three parts mechanically secured together: a lower circular part 904, an upper molding part 905 and an upper retaining part 906, the upper molding part 905 and the upper retaining part 906 delimiting laterally the upper part of the upper molding core 902.

The lower molding core 907 consists of three parts: a fixed outer core 908 which surrounds an intermediate bush 1000, which itself radially surrounds an inner core 909, the intermediate bush 1000 and the inner core 909 being moveable vertically. The outer core 908 and the inner core 909 are equipped with heat regulating systems 923 and 922 respectively. The heat regulating systems 922 and 923 are equipped with a heat exchanger edged in their upper part and/or in their lower part with seals.

An upper injection duct 918 traverses the upper molding core 902 longitudinally and emerges, in the region of its lower end, in the molding cavity 931.

A lateral injection duct 919 traverses the upper molding core 902 longitudinally and then the upper molding part 905, curves inward in the direction of the center of the molding device in the region of the lower circular part 904 and emerges, in the region of its lower end, in the molding cavity 932.

A retaining screw of the slide guide 912 mechanically secures a sliding guide 913 and a stripping plate 914. The stripping plate 914 is mechanically secured to a stripping device 901 by the combined action of an assembly ring 915 and cooperation of the shoulder 901b of the stripping device 901 with a stop 914a of the stripping plate 914.

The rear part of the slide mold 903 is guided in translation by cooperation of a shoulder 913b of the sliding guide 913 with a stop 904a of the circular part 904 of the slide mold 903. The rear part of the slide mold 903 is equally guided in translation by guiding devices (not shown) positioned in the transverse orifices 924.

From FIG. 16, the molding cavity 931 of the cover 1 is defined by the lower wall of the upper molding core 902 (for molding the upper face of the first anchoring part 11, of the articulated part 12 and of the protuberance 15), by the lower wall of the upper molding part 905 of the slide mold 903 (for molding the tongue 14d and the upper face of the second anchoring part 13), by the upper wall of the circular part 904 of the slide mold 903 (for molding the lower face of the cover 1 and the outer face of the fasteners 3 and 4), by the upper end of the retaining rods 916 and 917 which are, in the example described, blade inserts (for molding the inner face of the recesses 35 and 45) and by the upper end of the ejection insert 921 (for molding the inner face of the closing skirt 5).

The molding cavity 932 of the endpiece 2 is defined by the lower wall of the circular part 904 of the slide mold 903 (for molding the upper face of the endpiece 2 and the outer face of the peripheral covering skirt 8), by the upper wall of the outer core 908 of the lower molding core 907 (for molding the space included between the peripheral covering skirt 8 and the inner peripheral skirt 7) and by the upper wall of the inner core 909 of the lower molding core 907 (for molding the space included between the inner peripheral skirt 7 and the sealing skirt 6 and in particular for molding the stop 72 and the central lower face of the endpiece 2).

During molding, the same material, or even different materials that may have different colors, is/are injected into the center of the molding cavities 931 and 932 through the upper injection channels 918 and lower injection channels 919 respectively.

After hardening the molded parts which are, from FIGS. 15 and 16, the cover 1 and endpiece 2, the upper molding core 902 is pulled vertically upwards by traction means that are not shown.

Then, almost simultaneously, each part of the slide mold 903 (composed of a lower circular part 904, of an upper molding part 905 and an upper retaining part 906) is moved in translation in the direction away from the molding cavities 931 and 932. The transverse traction means for each part of the slide mold are not shown in FIG. 15. As stated previously, the rear part of the slide mold 903 is guided in translation by cooperation of the shoulder 913b of the slide guide 913 with the stop 904a of the circular part 904 of the slide mold 903. The rear part of the slide mold 903 is also guided in translation by guiding devices (not shown) positioned in the transverse orifices 924.

After withdrawing the upper molding core 902 and each part of the slide mold 903, the space included between the endpiece 2 and the cover is free. Assembly can then take place.

For this, a press (not shown) is actuated and induces a vertical upwards translational movement (by intermediate parts not shown) to the inner core 909 and to the intermediate bush 1000 as well as the stripping plate 914, which, secured to the stripping device 901, pushes the stripping device 901 upwards. The vertical translational movement is submitted to the endpiece 2 by cooperation of the radial stop 901a of the stripping device 901 with the lower face of the peripheral covering skirt 8 and by cooperation of the upper end of the inner core 909 with the inner face of the sealing skirt 5. The endpiece 2 slides in the direction of the cover 1 until the fasteners 3 and 4 become engaged in the latching orifices 21 and 23 respectively. This assembly step is made possible by the fact that the cover 1 is immobilized by the upper end of the retaining rods 916 and 917 and by the upper end of the ejection insert 921.

The outer core 908 of the lower molding core 907 remains fixed while the press is actuated. Thus, upward vertical translation of the inner core 909 and of the intermediate bush 1000 relative to the outer core 908, which itself remains fixed, enables the parts molded by the outer core 908 to be demolded.

Finally, the vertical upwards thrust by the stripping device 901 is continued after assembly of the endpiece 2 and the cover 1, so as to eject the assembled dispensing head TD1 and to demold the stop 72.

After ejecting the assembled dispensing head TD1, the various elements making up the molding device are replaced in the previously described molding arrangement so as to reconstitute the molding cavities 931 and 932 for a new molding/assembly step.

Dispensing heads according to the variant of the first embodiment TD1′, according to the second embodiment TD2 or any other product having at least two molded parts which are assembled in a similar molding device, fall within the scope of the present invention.

Similarly, molding devices or dispensing heads having alternative structures also fall within the scope of the present invention.

Although the invention has been described in relation to particular embodiments, it is obvious that it is in no way limited thereto and comprises all equivalent techniques of the means described as well as combinations thereof if these fall within the scope of the invention.

1. A method for molding and assembling at least one first part (1, 101, 201, 301, 401, 501, 601, 701, 801, 1001) with at least one second part (2, 202, 402, 502, 602, 702, 802, 1002) comprising steps consisting in:
molding said first and second parts in two separate molding cavities (931, 932) of the same molding device, said molding device comprising a first molding cavity (931) for molding the first part and a second molding cavity (932) for molding the second part, and at least one retractable mold part (903) positioned between said molding cavities (931, 932), said molding device including a retaining rod (916, 917) having an end partially defining said first molding cavity (931), said first part including at least one fastener (3, 4, 213, 304, 404, 703, 1013), said fastener having a recess (35, 45, 213e, 445, 1013a) receiving the end of the retaining rod (916, 917) and being overmolded on said end of the retaining rod (916, 917), said second part having at least one latching orifice (21, 23, 221c, 723) traversed by said retaining rod (916, 917), on which each fastener is designed to be subsequently latched;
performing partial demolding by withdrawing the retractable mold part (903) so as to free at least the space included between the first molded part and the second molded part while holding said first part by the end of the retaining rod (916, 917);
assembling the first part and the second part by a relative movement of the first part and/or of the second part in the direction of said retaining rod (916, 917) until each fastener is engaged on the corresponding said latching orifice,
the frictional forces between at least one said recess and said end of the retaining rod (916, 917) being greater than the force for inserting said fastener through the latching orifice; and
ejecting the assembled first part and second part.

2. The molding and assembling method as claimed in claim 1, in which said molding cavities (931, 932) are arranged in relation to each other so that the relative movement for assembling said first part and said second part is a translational movement.

3. A product-dispensing head (TD1, TD1′, TD2, TD2′, TD3, TD4, TD5, TD6, TD7, TD8) derived in particular from the method as claimed in claim 1, comprising an endpiece (2, 202, 402, 502, 602, 702, 802, 1002) designed to be placed on a receptacle containing a product to be dispensed, said endpiece comprising a dispensing orifice (22, 222, 522, 622a, 622b, 722a, 722b), said product-dispensing head comprising a cover (1, 101, 201, 301, 401, 501, 601, 701, 801, 1001) designed to close said dispensing orifice of said endpiece, said cover having at least one fastener (3, 4, 213, 304, 404, 703, 1013), said endpiece having at least one latching orifice (21, 23, 221c, 723) designed to receive said fastener and a stop (21a, 21b, 23a, 23b, 221a, 1002b) positioned laterally outside said latching orifice, said fastener having a body (32, 42, 213b) extending projecting from the plane of said cover in a direction termed the “longitudinal direction” away from the cover, said fastener having at least one latching lug (33, 34, 43, 44, 213c, 213d, 443, 444, 1013b) connected to said body (32, 42, 213b) characterized in that said at least one latching lug is inclined with respect to said longitudinal direction toward the plane of said cover in the direction of said body (32, 42, 213b), and in that said at least one latching lug is capable of folding back longitudinally against said body (32, 42, 213b) when passing into the latching orifices, of folding back after passing into the latching orifices and of butting against the stop of the endpiece.

4. The head as claimed in claim 3, characterized in that said at least one latching lug (33, 34, 43, 44, 213c, 213d, 443, 444, 1013b) is flat and perpendicular to the plane termed the “demolding plane” of the cover (1, 101, 201, 301, 401, 501, 601, 701, 801, 1001).

5. The head as claimed in either claim 3, characterized in that said fastener (3, 4, 213, 304, 404, 703, 1013) has a cross section of which the larger dimension (L) is perpendicular to said demolding plane.

6. The head as claimed in claim 3, characterized in that said recess (35, 45, 213e, 445, 1013a) has a non-circular section matching the shape of said fastener (3, 4, 213, 304, 404, 703, 1013).

7. The head as claimed in claim 3, characterized in that the fastener (3, 4, 213, 304, 404, 703, 1013) has at least two latching lugs (33, 34, 43, 44, 213c, 213d, 443, 444, 1013b) that are symmetrical with respect to the middle plane of the fastener perpendicular to said demolding plane.

8. The head as claimed in claim 3, characterized in that said cover (1, 101, 301, 401, 601, 801) has at least one first anchoring part (11, 111) of which the lower part defines the fastener (3, 4, 304, 404), and an articulated part (12, 112, 412, 612a, 612b, 812), said articulated part being connected to said first anchoring part (11, 111) by a part forming a hinge (17), said cover closing said dispensing orifice (22, 222, 622a, 622b) in a position termed the “closed position”.

9. The head as claimed in claim 8, characterized in that said cover (1, 101, 301, 401, 601, 801) has additionally a second anchoring part (13, 113, 313, 413, 613a, 613b) separated from said first anchoring part (11, 111) by said articulated part (12, 112, 412, 612a, 612b, 812).

10. The head (TD1, TD1′, TD3, TD4, TD6, TD8) as claimed in claim 9, characterized in that said articulated part (12, 112, 412, 612a, 612b, 812) is connected to said second anchoring part (13, 113, 313, 413, 613a, 613b) by a detachable part (14, 114, 314, 414, 614, 814).

11. The head (TD1, TD1′, TD3, TD6) as claimed in claim 10, characterized in that said detachable part (14, 114, 314, 614) is in the form of a tongue (14d, 114b, 314b, 314c, 614a, 614b) projecting from the side of the wall termed the “upper wall” of said cover (1, 101, 301, 601), said tongue being torn off before said head is first used.

12. The head (TD8) as claimed in claim 10, characterized in that said detachable part (814) is in the form of a folding shutter having a separable zone (814a), a folding part (814b) and a zone forming a hinge (814c) attached to the lateral surface of the endpiece (802), said folding part (814b) connecting said zone forming a hinge (814c) and one end of said articulated part (812), said separable zone (814a) being designed to be broken by forcing in said folding part (814b), before said head (TD8) is first used.

13. The head (TD4) as claimed in claim 10, characterized in that said detachable part (414) has a separable zone (414a) and a moveable part (414b, 414c, 414d), said moveable part being connected to one end of said articulated part (412), said separable zone (414a) being designed to be broken by forcing in said moveable part in the direction of the endpiece (402), before said head (TD4) is first used.

14. The head as claimed in claim 9, characterized in that the first anchoring part (11, 111) and the second anchoring part (13, 113, 313, 413, 613a, 613b) and the articulated part (12, 112, 412, 612a, 612b, 812) each has an upper part (11a, 111a; 12a, 112a; 13a, 113a), the plane of said upper part of said articulated part (12a, 112a) extending in a plane perpendicular to the demolding plane and said upper part of the second anchoring part (13a, 113a) extending in a plane defining, with the plane of said upper part of said articulated part (12a, 112a), an angle of less than 180° turned toward the upper part of the dispensing head.

15. The head as claimed in claim 8, characterized in that said articulated part (12, 112, 412, 612a, 612b, 812) has additionally a closing skirt (5) projecting from said cover (1, 101, 301, 401, 601, 801) in a direction termed the “longitudinal direction” away from the face termed the “upper face” of the cover (1, 101, 301, 401, 601, 801), said closing skirt (5) being designed to be received in said dispensing orifice (22, 222, 522, 622a, 622b, 722a, 722b).

16. The head as claimed in claim 8, characterized in that said articulated part (12, 112, 412, 612a, 612b, 812) has a protuberance (15, 115, 415, 512c) protecting from the side of the wall termed the “lateral wall” of said articulated part facing the second anchoring part (13, 113, 313, 413, 613a, 613b).

17. The head as claimed in claim 3, characterized in that said endpiece (2, 202, 402, 502, 602, 702, 802, 1002) has a peripheral covering skirt (8) and a peripheral inner skirt (7), and that each latching orifice (21, 23, 221c, 723) is situated between said peripheral covering skirt (8) and said inner peripheral skirt (7).

18. The head (TD1, TD1′, TD3, TD4, TD6, TD8) as claimed in claim 3, characterized in that it has a secondary stop (423a, 423b) situated beyond said stop (21a, 21b, 23a, 23b) in the extension of the latching orifice (21, 23, 221c, 723) of the endpiece (2, 202, 402, 502, 602, 702, 802, 1002), laterally to the outside of said latching orifice, said latching lug being able to unfold so as to butt against said secondary stop.

19. The head (TD2, TD2′) as claimed in claim 3, characterized in that said cover (201, 1001) has an upper part forming a shoulder (211, 1011), a lower part defining the fastener (213, 1013), an intermediate part (212, 1012) connecting said upper part (211, 1011) and said fastener (213, 1013) and a dispensing channel (214, 1013a, 1013a), and in that said latching orifice is in the form of a tubular sleeve (221, 1002d) in which said intermediate part (212, 1012) of the cover (201, 1001) slides longitudinally so that said shoulder (211, 1011) or said fastener (213) can butt up selectively against said tubular sleeve (221, 1002d), said tubular sleeve (221, 1002d) having a traversing orifice (205, 1002a) able to come facing the dispensing channel (214, 1012a) in a position termed the “open position” and able to come facing the lateral wall of said intermediate part (212, 1012) in a position termed the “closed position”.

20. The head (TD2, TD2′) as claimed in claim 3, characterized in that the internal diameter of said tubular sleeve (211, 1011) is substantially equal to the external diameter of said intermediate part (212, 1012) which slides in the tubular sleeve (211, 1011).

21. The head (TD1′, TD2′) as claimed in claim 8, characterized in that said articulated part (112) of the cover (101) or said cover (1001) has additionally a gripping means (118, 1011a) projecting from the side of the wall termed the “upper wall” of the cover (1, 101).

22. The head (TD1, TD1′) as claimed in claim 3, characterized in that said cover (701) has a lower part forming a fastener (703) and an intermediate part (712) positioned facing the upper wall of said latching orifice (723), and in that said latching orifice (723) is in the form of a traversing slot in which said fastener (703) is housed slidingly so that said intermediate part (712) can selectively close and uncover the dispensing orifice (722a, 722b).
